(19) United States
(12) Patent Application Publication
(10) Pub. No.: US 2005/0271453 A1
(43) Pub. Date: Dec. 8, 2005

(54) Lotion application apparatus

(76) Inventor: John Y. Haneda, Montebello, CA (US)

Correspondence Address: MURAMATSU & ASSOCIATES, 114 PACIFICA, SUITE, IRVINE, CA, 92618, US

(21) Appl. No.: 10/861,548

(22) Filed: Jun. 4, 2004

(51) Int. Cl. A46B 11/00; B43K 8/24

(52) U.S. Cl. 401/125; 401/123

(57) ABSTRACT

A lotion application apparatus is configured by a lotion applicator and a lotion bottle where the lotion applicator is detachably attached to the lotion bottle. The lotion application apparatus can be extendable to reach a desired body part while compact enough to fit to the lotion bottle. The sponge portion of the applicator can be a roller that can rotate about a central shaft to quickly apply the lotion to a wide area of the user's body.

### FIELD OF THE INVENTION

This invention relates to lotion application apparatus, and more particularly, to a lotion application apparatus that enables a user to easily reach her back or any other part of her body to apply lotion, medicine, ointment, etc.

### BACKGROUND OF THE INVENTION

Lotion or the like is commonly used for various purposes. For instance, people find it necessary to apply sunscreen lotion to avoid sunburn when exposed to the sun. In such a case, it is difficult to apply lotion on one's back since it is difficult to reach the area by hands. People often need to resort to help of others to apply lotion to a hard-to-reach area.

However, it is cumbersome to ask for help every time lotion is to be applied. Moreover, helping hands may not be available when needed. Therefore, an appropriate lotion application device is desired that can be produced economically and is simple in construction. Further, it is desired that such a lotion application apparatus is easily carried around without being lost because people often forget where they stored the application device.

### SUMMARY OF THE INVENTION

The present invention aims to solve the problems described above. It is, therefore, an object of the present invention to provide a lotion application apparatus which is low cost and easily carried around.

It is another object of the present invention to provide a lotion application apparatus configured by a lotion applicator and a lotion bottle where the applicator can be easily attached to the lotion bottle.

It is a further object of the present invention to provide lotion application devices of different sizes and shapes suitable for particular purposes.

In one aspect of the present invention, the lotion application apparatus is comprised of a handle portion by which a user grips the lotion application apparatus to spread lotion on the user's body, a sponge portion to which lotion is applied, a rod portion between the handle portion and the sponge portion that can be extendable therebetween, and a lotion bottle having a dented portion to receive the handle portion, the sponge portion and the rod portion therein. In one example, the rod portion has a telescopic mechanism to be extendable. Preferably, the rod portion is provided with a locking mechanism to fix the extendable rod portion to a desired length. The lotion application apparatus can be advantageously manufactured with plastic.

The lotion bottle of the apparatus has a dented portion that has a shape similar to that of the lotion applicator to store the lotion applicator therein. In the alternative, the lotion bottle has a dented portion that has the shape of a rectangle to store the lotion applicator of any size or shape therein.

In a further aspect of the present invention, the lotion application apparatus is comprised of a rod portion, one end of which is held by a user as a handle and the other end is connected to a sponge portion, wherein the sponge portion is to spread the lotion to user's body. Punched out patterns may be provided on the rod portion to reduce weight and cost. A hook string may be tied to the handle end of the rod portion to allow the lotion application apparatus to be hung to a desired spot. The sponge portion may be a roller that rotates about a shaft when lotion is applied to the user's body. The shaft may be supported from both ends or from only one end thereof.

According to the present invention, a lotion application apparatus can be easily used and manufactured with low cost. The lotion applicator is attached to the lotion bottle so that it can be easily carried around and easily found when needed. Moreover, the sponge portion of the lotion application apparatus can be a roller that allows quick application of the lotion on wide areas of the body.

### BRIEF DESCRIPTION OF THE DRAWINGS

In the first embodiment, the lotion application apparatus is configured by a lotion applicator and a lotion bottle. FIGS. 1A-1E show an example of structure of the lotion applicator of the present invention where FIG. 1A is a front view thereof where the rod is not elongated, FIG. 1B is a front view thereof where the rod is elongated, FIG. 1C is a schematic view showing an upper rod portion and lower rod portion thereof to explain the structure of the rod portion, FIGS. 1D and 1E are schematic views showing the structure of the stopper mechanism thereof.

FIG. 2 is a front view showing the first embodiment of the lotion application apparatus where the lotion applicator is held by the lotion bottle in accordance with the present invention.

FIG. 3 is a cross sectional side view of the lotion application apparatus and the lotion bottle of the present invention corresponding to FIG. 2.

FIG. 4 is a front view showing another embodiment of the lotion application apparatus configured by the lotion applicator and the lotion bottle where the lotion bottle that holds the lotion applicator in accordance with the present invention.

FIG. 5 is a front view showing another embodiment of the lotion application apparatus of the present invention having a plate type rod.

FIGS. 6A-6D are schematic diagrams showing examples of the lotion application apparatus of the present invention having a roller sponge portion, where FIG. 6A is a front view thereof where the shaft of the roller is supported at both sides thereof, FIG. 6B is a side view thereof corresponding to FIG. 6A, FIGS. 6C and 6D are front views thereof showing examples of attachment mechanism at the roller sponge portion.

FIG. 7 is a front view showing a further example of the lotion application apparatus with a roller sponge portion where the shaft of the roller sponge portion is supported at one side.

### DETAILED DESCRIPTION OF THE INVENTION

The present invention will now be described in detail with reference to the accompanying drawings. The lotion application apparatus of the present invention is designed to be easily carried around to anywhere the lotion and the like is used. It should be noted that the word “lotion” is used for an illustration purpose, thus should not be limited to its particular meaning. For example, the word “lotion” includes anything that is applied to the skin such as tanning oils, moisturizing oils, and sun screens, skin creams, medicines, etc.

One embodiment of the present invention is a lotion application apparatus formed of a lotion applicator and a lotion bottle that can be easily fixed together so that the lotion application apparatus can be easily found when needed. FIG. 1A is a front view showing a lotion applicator of the present invention where the rod is not elongated. As shown, the lotion applicator 101 comprises a handle portion 21, a rod portion 25, and a sponge portion 29. The lotion applicator 101 is made of, for example, plastic through plastic molding.

The handle portion 21 is a part to be held by a user to control the direction of the sponge portion 29. The rod portion 25 enables the sponge portion 29 to reach a desired area on the user's body. The sponge portion 29 is bonded to the rod portion 25 by, for example, water-resistant adhesive. The lotion is placed on the sponge portion 25 by which the user reaches the back or other hard-to-reach areas of the body. The material for the sponge portion 25 is not limited to conventional sponge but can take any other suitable material, such as paper, gauze, blush, etc. As will be explained later, preferably, the rod portion 25 is designed to extend to a certain length.

As shown in FIG. 1F, it is also feasible to attach the sponge portion 29 to the rod portion 25 by providing an end hook 71 at the end of the rod portion 25 to securely connect the rod portion 25 and the sponge portion 29. In this example, the end hook 71 is T-shaped and represented by the dotted lines to indicate that it is inside the sponge portion 29. A hole (not shown) is provided to the sponge portion 29 into which the end hook 71 is inserted. The inside of the sponge portion 29 is so formed as to snugly fit the end hook 71. This configuration allows the sponge portion 29 and the rod portion 25 to be attached firmly together without an adhesive, although an adhesive can also be used to further strengthen the bonding.

FIG. 1B is a front view showing the lotion applicator apparatus of the present invention where the rod portion 25 is elongated. The lotion application apparatus depicted in FIG. 1B is identical to the one shown in FIG. 1A except that the rod portion 25 of FIG. 1B is elongated. As shown, the rod portion 25 is elongated by almost two times of the original length thereof.

The structure of the rod portion 25 is explained with reference to FIG. 1C to 1E. The rod portion 25 is configured by an upper rod portion 25b and a lower rod portion 25a where it is designed that the upper rod portion 25b telescopically fits in the lower rod portion 25a. A stopping mechanism is provided to the upper and lower rod portions 25a and 25b so that the rod portion can be fixed to a certain length.

FIG. 1D shows the condition where the upper rod portion 25b is not fixedly latched to the lower rod portion 25a. FIG. 1E shows the condition where the upper rod portion 25b is fixedly latched to the lower rod portion 25a. A concave part 61 is formed at an appropriate point of the upper rod portion 25b. A convex part 63 is formed at an appropriate point of the lower rod portion 25a. The convex part 63 and the concave part 61 are so designed that they fit with each other. Thus, unless a strong force is exerted to the rod portions, the position of the upper rod portion 25b and lower rod portion 25a is maintained.

It should be noted that the stopping mechanism described above is just one example, and there are many other ways to achieve the stopping mechanism within the purview of this invention. In the above example, the rod portion 25 comprises the upper rod portion 25b and the lower rod portion 25a so that the rod potion telescopically extends one time. However, an additional rod portion can be provided to further extend the overall length if necessary.

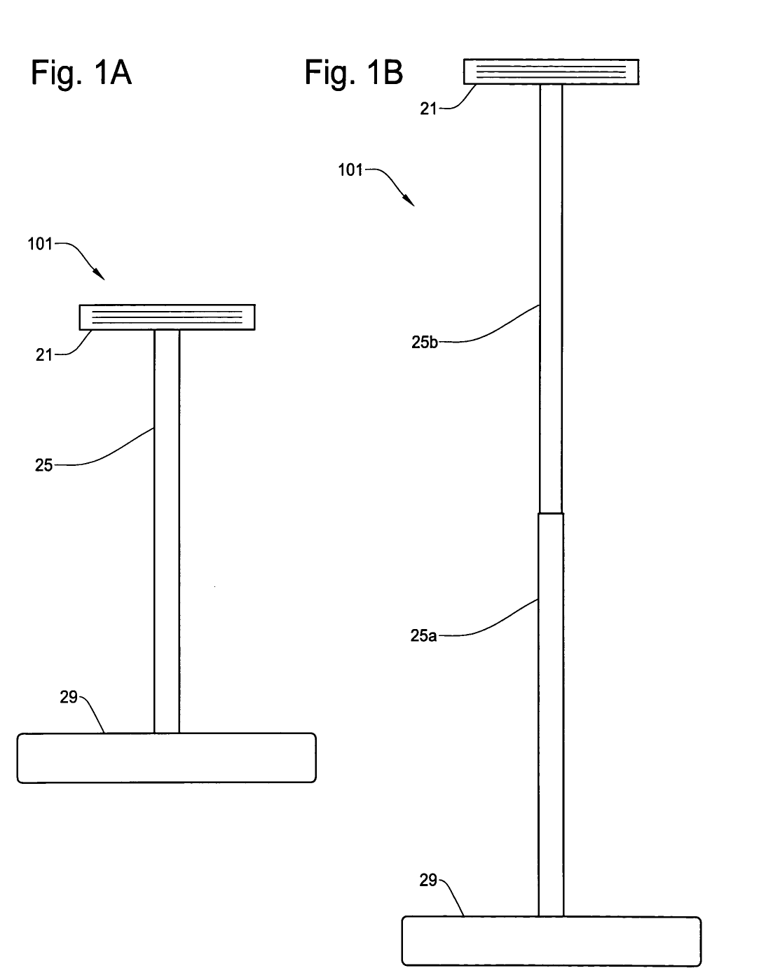

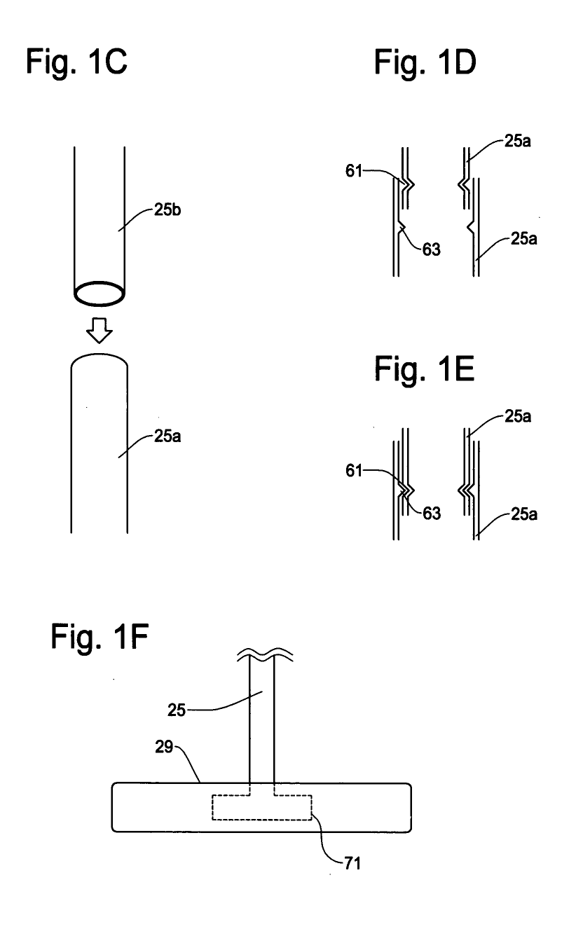

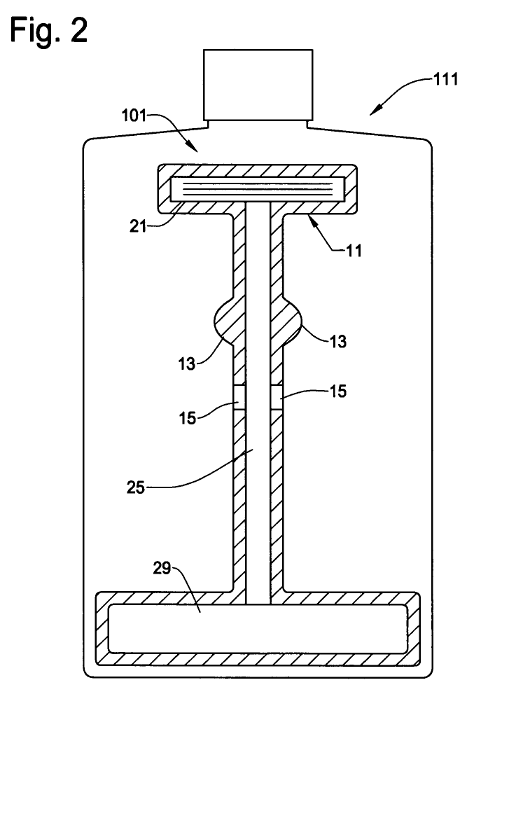

The design of the lotion applicator shown in FIGS. 1A-1E is primarily intended to be coupled to the lotion bottle. FIG. 2 is a front view showing the lotion application apparatus configured by the lotion bottle and the lotion bottle in accordance with the present invention. It is so designed that the lotion bottle holds the lotion applicator on its outside surface, thereby avoiding to lose or forget the lotion application apparatus. A lotion bottle 111 normally contains lotion to be applied to the user's body, such as sunscreen lotion.

In FIG. 2, the lotion applicator 101 is made of the handle portion 21, the rod portion 25, and the sponge portion 29. The lotion bottle 111 has a dented area (recess) 11 which is indicated by the hatch and a clip portion 15. The lotion applicator 101 fits into the dented area 11 of the lotion bottle and is supported by the clip portion 15. The clip portion 15 has an appropriate width to clip the rod portion 25 of the lotion applicator 101. Although only one set of clip portion is shown, two or more clip portions can be provided to more securely support the lotion applicator 101. In this embodiment, a finger notch part 13 is provided to the dented area 11 so that a user can easily take out or put in the lotion applicator 101 by inserting fingers in the finger notch part 13.

The lotion applicator 101 coupled with the lotion bottle 111 shown in FIG. 2 can avoid the need to find the lotion application apparatus because the application apparatus comes as one set. Accordingly, the user can avoid frustration in searching for the lotion application apparatus. The lotion bottle 111 and the lotion applicator 101 may be provided to the user as a set. Alternatively, they may also be provided separately, thereby allowing a user to obtain a new lotion applicator while retaining the lotion bottle or vice versa.

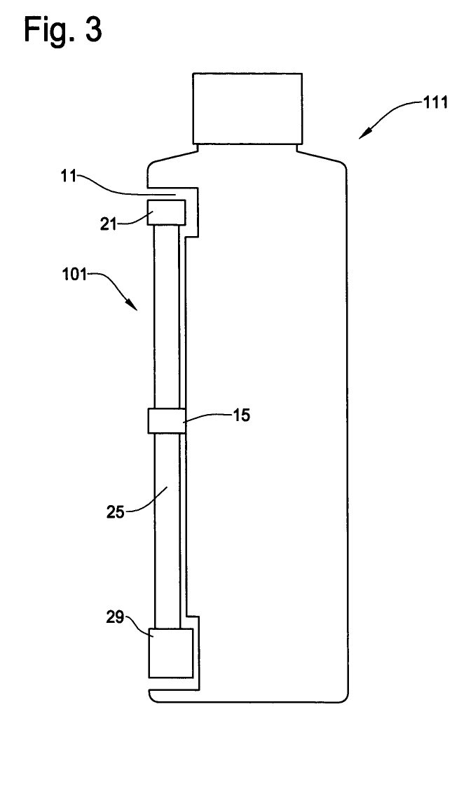

FIG. 3 is a cross sectional side view of the lotion application apparatus configured by the lotion applicator 101 and the lotion bottle 111 shown in FIG. 2. As shown, the dented area 11 having a hollow is formed on a surface of the lotion bottle 111. The lotion applicator 101 is held in the dented area 11 by the clip portion 15. In this embodiment, the areas at which the handle portion 21 and the sponge portion 29 are located are dented further to accommodate the dimension of those portions.

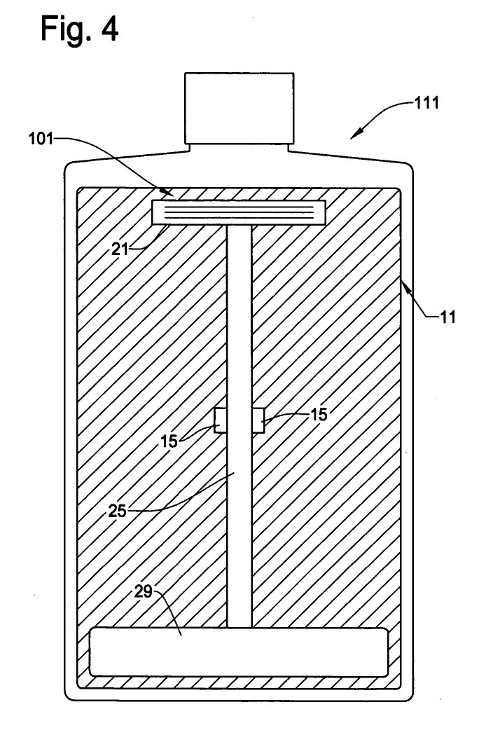

FIG. 4 is a front view showing another set of the lotion application apparatus configured by the lotion applicator 101 and the lotion bottle 111 in the first embodiment of the present invention. In this example, the dented portion 11 of the lotion bottle 111 has the shape of a square. In other words, unlike the example of FIG. 2, the dented portion 11 does not follow the particular shape of the lotion applicator 101. This construction is effective when the size or shape of the sponge portion and the handle portion of the lotion applicator can vary.

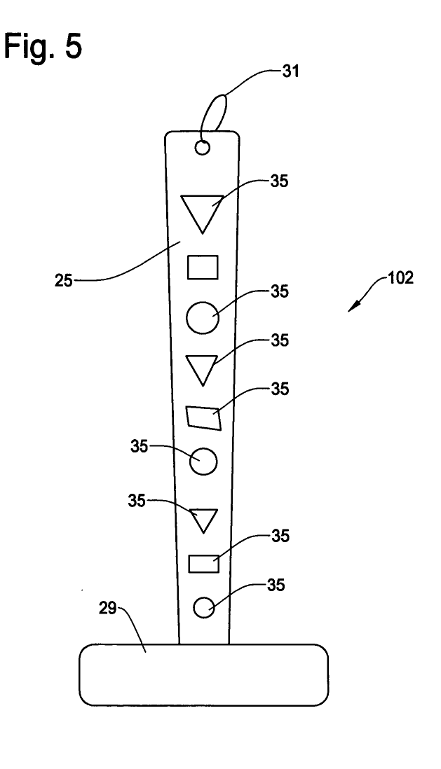

The second embodiment of the lotion application apparatus of the present invention is described with reference to the front view of FIG. 5. The lotion application apparatus 102 mainly comprises a rod portion 25, and a sponge portion 29. The rod portion 25 enables the sponge portion 29 to reach a desired area of the user's body to apply lotion or the like.

The user grips the end of the rod portion opposite to the sponge portion 29. A hook string 31 is provided so that the lotion application apparatus 102 can be easily hung on a desired spot. Holes 35 of various patterns are provided to give aesthetic appearance and reduce overall weight and cost. In this example, the holes 35 take the shape of circle, rectangle and triangle, but other shapes or patters are also feasible.

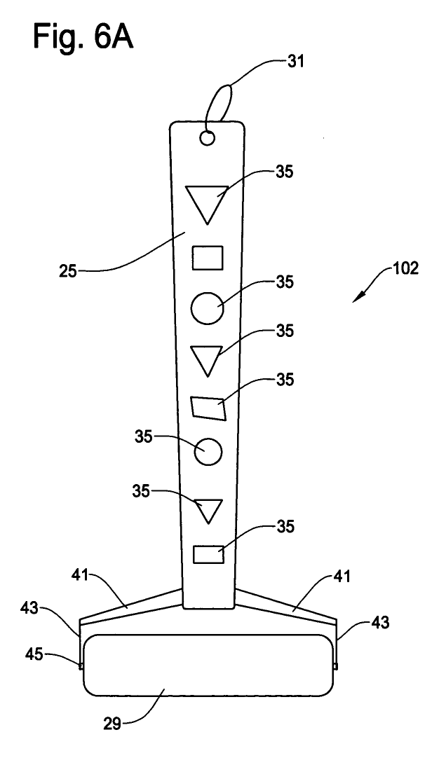

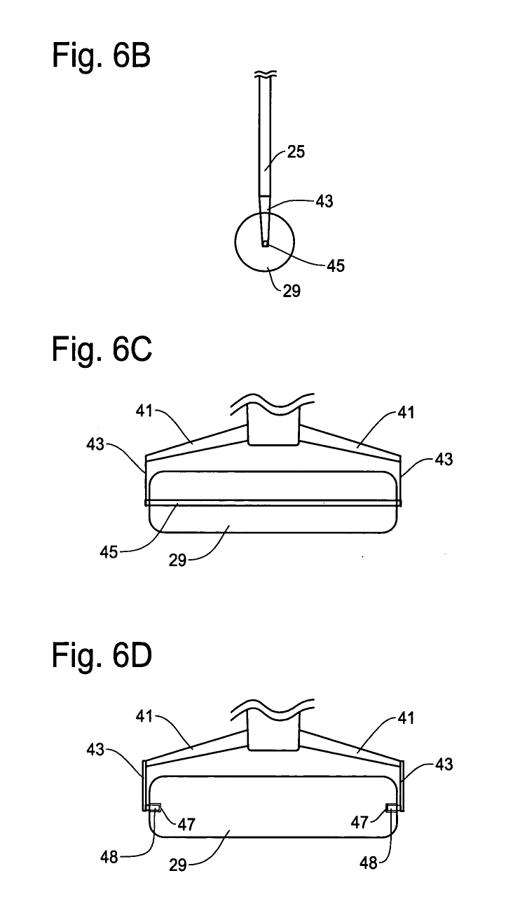

FIG. 6A is a front view showing a further example of the lotion application apparatus with a roller sponge portion 29 where a shaft 45 of the roller is supported from both sides. The lotion application apparatus 102 mainly comprises a rod portion 25, and a sponge portion 29 that has a structure of a roller. The rod portion 25 is identical to that shown in FIG. 5. The sponge portion 29 is a roller that can rotate about the shaft 45.

This construction allows smooth and efficient application of lotion quickly on a wide area of the user's body. The shaft 45 is supported by the side support portions 43 at both sides, and the side support portions 43 are fixed to the side extension portions 41. The rod portion 25, the side support portions 43 and the side extension portions 41 can be integrally formed through plastic molding. FIG. 6B is a side view showing the roller sponge portion of the lotion application apparatus of FIG. 6A.

FIG. 6C is a schematic view showing the roller sponge portion of the lotion application apparatus in FIG. 6B to explain the relationship between the roller and the shaft. In this drawing, the shaft 45 is made visible through the sponge portion 29 only for an illustration purpose. Both ends of the shaft 45 are projected from the roller sponge portion 29 and are fitted to the side support portions 43.

An alternative method to attach the roller sponge portion 29 is described with reference to FIG. 6D. In this example, the shaft does not penetrate all though the sponge portion 29. Rather, holes 47 are provided at both sides of the sponge portion 29. Projection portions 48 inwardly formed on the side support portions 43 fitted in the holes 47 on the roller sponge portion 29.

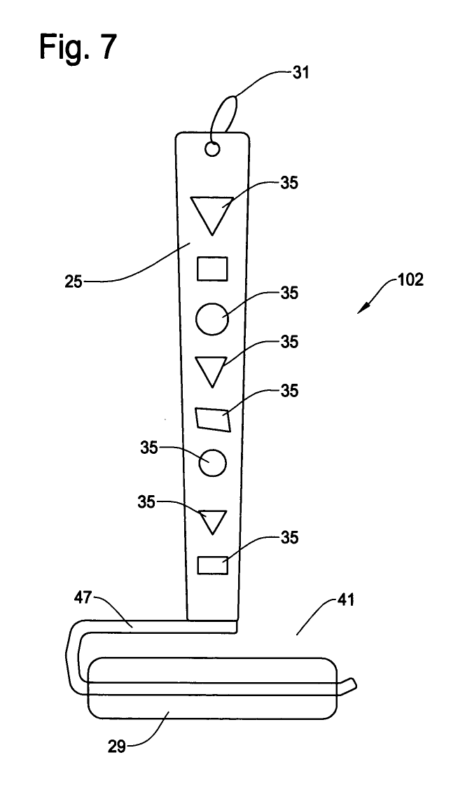

FIG. 7 is a front view showing an example of the lotion application apparatus with a roller sponge portion where the shaft of the roller is supported from one side thereof. The lotion application apparatus 102 is functionally identical to that shown in FIG. 6A. The shaft portion 47 functions as an equivalent to the parts corresponding to the side extension portions 41, side support portions 43 and the shaft 45 of FIGS. 6A-6D. The shaft portion 47 is made visible through the sponge portion 29 for an illustration purpose only to clearly illustrate the relationship between the shaft portion 47 and the roller sponge portion 29. The end of the shaft portion 47 is bent slightly so that the sponge portion 29 will not slip out.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

1. A lotion application apparatus for applying lotions or other objects to a user's body, comprising:
a handle portion by which a user grips to apply and spread lotion on the user's body;
a sponge portion on which the lotion to be applied is placed;
a rod portion that extends from the handle portion to the sponge portion; and
a lotion bottle having a dented portion to receive the handle portion, the sponge portion and the rod portion therein.

2. A lotion application apparatus as defined in claim 1 further comprising a hook portion provided at an end of the rod portion, wherein the hook portion fits into a space provided inside of the sponge portion to firmly attach to the sponge portion.

3. A lotion application apparatus as defined in claim 1, wherein the rod portion is extendable by its telescopic structure.

4. A lotion application apparatus as defined in claim 3, wherein the rod portion has a locking mechanism to fix the rod portion to a desired length.

5. A lotion application apparatus as defined in claim 1, wherein the rod portion and the handle portion is made of plastic.

6. A lotion application apparatus as defined in claim 1, further comprising a clip portion in the dented portion on the lotion bottle to hold the rod portion.

7. A lotion application apparatus as defined in claim 6, wherein the dented portion of the lotion bottle has the shape of the handle portion, the sponge portion and the rod portion to store them therein.

8. A lotion application apparatus as defined in claim 6, wherein the dented portion of the lotion bottle has the shape of a rectangle to store the handle portion, the sponge portion and the rod portion without regard to the shapes thereof

9. A lotion application apparatus for applying lotions or other objects to a user's body, comprising:
a rod portion, one end of which is held by a user as a handle and the other end is connected to a sponge portion; and
a sponge portion on which the lotion to be applied is placed.

10. A lotion application apparatus as defined in claim 9, further comprising punched out patterns on the rod portion to reduce weight and cost.

11. A lotion application apparatus as defined in claim 9, further comprising a hook string portion that allows the lotion application apparatus to be hung on a desired spot.

12. A lotion application apparatus as defined in claim 9, wherein the sponge portion is a roller that rotates about a shaft positioned at the center thereof.

13. A lotion application apparatus as defined in claim 12, wherein the shaft projected from both ends of the roller is supported at both ends by side support portions of the rod portion.

14. A lotion application apparatus as defined in claim 9, wherein the sponge portion is a roller that rotates about a shaft where holes are formed on both ends of the roller wherein projections of side support portions of the rod portion fit-in the holes, thereby supporting the roller.

15. A lotion application apparatus as defined in claim 12, wherein the shaft is supported from one end and the other end is projected from another end of the roller and is bent slightly to prevent slip-out of the roller.
